(19) United States
(12) Patent Application Publication
(10) Pub. No.: US 2026/0225025 A1
(43) Pub. Date: Aug. 6, 2026

(54) CARBON DIOXIDE RECOVERY APPARATUS

(71) Applicant: HONDA MOTOR CO., LTD., Tokyo (JP)

(72) Inventors: Ryo Ninomiya, Wako-shi (JP); Toshiyuki Inaba, Wako-shi (JP)

(21) Appl. No.: 19/451,030

(22) Filed: Jan. 16, 2026

(30) Foreign Application Priority Data
Feb. 6, 2025 (JP) 2025-018278

(51) Int. Cl. B01D 53/04; F28F 9/02

(52) U.S. Cl. CPC B01D 53/0438; B01D 53/0462; B01D 2257/504; F28F 2009/0285

(57) ABSTRACT

A carbon dioxide recovery apparatus includes: a heat exchanger, which holds an adsorbent; a support structure, which is constituted to be capable of supporting the heat exchanger; a housing, which is constituted to be capable of accommodating an assembly with the heat exchanger supported by the support structure; and a slide member, which is disposed between the assembly and the housing, and which is constituted to make the assembly slidable in an insertion direction of inserting the assembly into the housing.

### CROSS-REFFERENCE TO RELATED APPLICATIONS

This application is based on and claims the benefit of priority from Japanese Patent Application No. 2025-018278 filed in Japan on February 06, 2025, the contents of which are hereby incorporated by reference in their entirety.

### BACKGROUND OF THE INVENTION

### Field of the Invention

The present invention relates to a carbon dioxide recovery apparatus.

### Description of Related Art

In the related art, efforts for the purpose of mitigating climate change or reducing its influence are continuously made, and in order to achieve this, research on carbon dioxide recovery apparatuses is conducted to reduce the emission amount of carbon dioxide (CO₂).

Japanese Unexamined Patent Application, First Publication No. 2024-10423 discloses a structure in which an inlet port for allowing a heat exchange fluid to flow into a heat exchange tube and an outlet port for allowing the heat exchange fluid to flow out of the inside of the heat exchange tube are provided on a frame.

Japanese Unexamined Patent Application, First Publication No. 2023-158284 discloses that two or more detachable adsorption rotors coupled to bosses are included in the width direction, coupling pins are provided on the bosses, and the numbers of rotations of the adsorption rotors are synchronized with each other.

### SUMMARY OF THE INVENTION

There is a problem in reducing the number of assembling steps of the carbon dioxide recovery apparatus.

In order to solve the above problem, it is an object of the present application to reduce the number of assembling steps of a carbon dioxide recovery apparatus. In addition, this contributes to mitigating climate change or reducing its influence, accordingly.

As a means for solving the above problem, according to aspects of the present invention, following constitutions are included.

(1) A carbon dioxide recovery apparatus (for example, a carbon dioxide recovery apparatus 1 according to an embodiment) according to one aspect of the present invention, includes: a heat exchanger (for example, a heat exchanger 50 according to an embodiment) that holds an adsorbent (for example, an adsorbent 12 according to an embodiment); a support structure (for example, a support structure 60 according to an embodiment) constituted to be capable of supporting the heat exchanger; a housing (for example, a housing 70 according to an embodiment) constituted to be capable of accommodating an assembly (for example, an assembly 55 according to an embodiment) with the heat exchanger supported by the support structure; and a slide member (for example, a slide member 80 according to an embodiment) disposed between the assembly and the housing, and constituted to make the assembly slidable in an insertion direction of inserting the assembly into the housing.

According to this constitution, it becomes possible to accommodate, in the housing, the assembly in which the heat exchanger is supported by the support structure. In addition, the slide member makes the assembly slidable in the direction of inserting the assembly into the housing. Thus, it becomes possible to achieve assembly work of the carbon dioxide recovery apparatus in a simple constitution in which the heat exchanger is supported by the support structure to form the assembly (a subassembly), and the assembly is made to slide in the housing. This constitution eliminates the need for inserting and fixing another guide member in assembling the heat exchanger, after the heat exchanger is inserted along the guide member, which is attached to the case. Therefore, it becomes possible to reduce the number of assembling steps of the carbon dioxide recovery apparatus. In addition, this contributes to mitigating climate change or reducing its influence, accordingly.

(2) In the carbon dioxide recovery apparatus described in the above (1), the slide member may be made of a material having a sliding property higher than a material of the housing.

According to this constitution, it becomes possible to make the assembly slide more smoothly than a case where the slide member is made of a material having a sliding property equal to or lower than that of the housing.

(3) In the carbon dioxide recovery apparatus described in the above (1) or (2), the slide member may be made of a material having a heat insulation property higher than a material of the housing.

According to this constitution, it becomes possible to further enhance the heat insulation property between the assembly and the housing, as compared with a case where the slide member is made of a material having a heat insulation property equal to or lower than that of the material of the housing.

(4) The carbon dioxide recovery apparatus described in one of the above (1) to (3) may further include a fixing structure (for example, a fixing structure 100 according to an embodiment), which is disposed between the assembly and the housing, and which is for fixing the assembly and the housing.

According to this constitution, it becomes possible to fix the assembly and the housing using the fixing structure.

(5) In the carbon dioxide recovery apparatus described in the above (4), the fixing structure may include: a fixing protrusion portion (for example, a fixing protrusion portion 101 according to an embodiment), which protrudes from the assembly toward the housing, in which a screw hole (for example, a screw hole 101a according to an embodiment) is formed; a female screw portion (for example, a female screw portion 102 according to an embodiment) provided in the housing; and a male screw (for example, a male screw 103 according to an embodiment) screwed into the female screw portion through the screw hole.

According to this constitution, the male screw is screwed into the female screw portion in the housing through the screw hole of the fixing protrusion portion on the assembly, and thus it becomes possible to fix the assembly and the housing.

(6) The carbon dioxide recovery apparatus described in one of the above (1) to (5) may further include a first restriction structure (for example, a first restriction structure according to an embodiment), which is disposed between the assembly and the housing, and which restricts a displacement of the assembly in the insertion direction.

According to this constitution, the first restriction structure is capable of restricting a displacement of (positioning) the assembly in the direction of inserting the assembly into the housing.

(7) In the carbon dioxide recovery apparatus described in the above (6), a fixing structure for fixing the assembly and the housing, and the first restriction structure may be disposed on opposite sides to each other in a height direction of the housing.

According to this constitution, it becomes possible to fix and position the assembly and the housing more stably than a case where the fixing structure and the first restriction structure are disposed on the same side in the height direction of the housing.

(8) In the carbon dioxide recovery apparatus described in the above (6) or (7), the first restriction structure may include: a first restriction protrusion portion (for example, a first restriction protrusion portion 111 according to an embodiment), which protrudes from the assembly toward the housing; and an abutment portion (for example, an abutment portion 112 according to an embodiment), which is disposed on the housing, and which abuts the first restriction protrusion portion in the insertion direction.

According to this constitution, the abutment portion on the housing is brought into contact with the first restriction protrusion portion on the assembly, and thus it becomes possible to restrict the displacement of (position) the assembly in the direction of inserting the assembly into the housing.

(9) The carbon dioxide recovery apparatus described in one of the above (1) to (8) may further include a second restriction structure (for example, a second restriction structure 120 according to an embodiment), which is disposed between the assembly and the housing, and which restricts a displacement of the assembly in a direction that intersects the insertion direction.

According to this constitution, the second restriction structure is capable of restricting a displacement of (positioning) the assembly in the intersecting direction, in inserting the assembly into the housing.

(10) In the carbon dioxide recovery apparatus described in the above (9), the fixing structure for fixing the assembly and the housing, and the second restriction structure may be disposed on opposite sides to each other in a width direction of the housing.

According to this constitution, it becomes possible to fix and position the assembly and the housing more stably than a case where the fixing structure and the second restriction structure are disposed on the same side in the width direction of the housing.

(11) In the carbon dioxide recovery apparatus described in the above (9) or (10), the second restriction structure may include: a second restriction protrusion portion (for example, a second restriction protrusion portion 121 according to an embodiment), which protrudes from the assembly toward the housing, and in which a long hole (for example, a long hole 121a according to an embodiment) is formed; and a pin (for example, a pin 122 according to an embodiment), which is disposed in the housing, and which is inserted into the long hole.

According to this constitution, by inserting the pin on the housing into the long hole of the second restriction protrusion portion on the assembly, it becomes possible to restrict the displacement of (position) the assembly in the intersecting direction, in inserting the assembly into the housing.

(12) In the carbon dioxide recovery apparatus described in one of the above (1) to (11), the support structure may include a side plate portion (for example, a side plate portion 63 according to an embodiment), which is disposed on an outer side in a width direction of the assembly, and which includes a recess portion (for example, recess portions 63a and 63b according to an embodiment) formed to be capable of accommodating an end portion of the heat exchanger.

According to this constitution, the end portions of the heat exchanger are accommodated in the recess portions of the side plate portion of the support structure, and thus the assembly can be formed.

(13) In the carbon dioxide recovery apparatus described in the above (12), the recess portion may be formed in a groove shape that conforms to the shape of the end portion of the heat exchanger.

According to this constitution, the end portions of the heat exchanger are accommodated in the recess portions, each of which is formed in a groove shape that conforms to the shape of the end portion of the heat exchanger, so that the heat exchanger can be positioned with respect to the side plate portion of the support structure. This eliminates the need for a separate member for positioning the heat exchanger, so that the assembly can be simplified.

(14) The carbon dioxide recovery apparatus described in one of the above (1) to (13) may further include a header (for example, a header 90 according to an embodiment), which is disposed inside the housing, and which is for circulating a heat medium into the heat exchanger.

According to this constitution, heat radiation from the header to the outside air can be reduced as compared with a case where the header is provided outside the housing. Accordingly, heat loss can be reduced.

(15) The carbon dioxide recovery apparatus described in the above (14) may further include: a circulation structure (for example, a circulation structure 130 according to an embodiment), which is disposed outside the housing, and which is for flowing the heat medium; and piping (for example, piping 140 according to an embodiment), which penetrates into the housing to communicate inside of the circulation structure with inside of the header to circulate the heat medium into the header.

According to this constitution, the piping, which penetrates into the housing, enables the inside of the circulation structure in the outside of the housing and the inside of the header in the inside of the housing to communicate with each other. Thus, escape of the heat of the heat medium to the housing can be suppressed.

(16) In the carbon dioxide recovery apparatus described in the above (15), the piping may have flexibility.

According to this constitution, thermal expansion of the housing and the header can be absorbed by the pipe having flexibility.

(17) In the carbon dioxide recovery apparatus described in one of the above (1) to (16), a pair of the slide members may be disposed on both outer sides in a width direction of the housing.

According to this constitution, the assembly is capable of sliding more stably than a case where the slide member is disposed on only one outer side in the width direction of the housing.

(18) In the carbon dioxide recovery apparatus described in the above (17), a fixing structure for fixing the assembly and the housing, and one fastening portion of the pair of slide members may be disposed on an identical side in a width direction of the housing.

According to this constitution, fixing with the fixing structure and fastening of one of the slide members can be conducted on the same side in the width direction of the housing.

According to the present invention, it becomes possible to reduce the number of assembling steps of the carbon dioxide recovery apparatus. In addition, this contributes to mitigating climate change or reducing its influence, accordingly.

### BRIEF DESCRIPTION OF THE DRAWINGS

FIG. 1 is a schematic view of a carbon dioxide recovery apparatus according to an embodiment;

FIG. 2 is a perspective view illustrating a state in which an intake unit and an exhaust unit are removed, in the carbon dioxide recovery apparatus according to an embodiment;

FIG. 3 is a perspective view of an assembly according to an embodiment;

FIG. 4 is an exploded perspective view of the assembly according to an embodiment;

FIG. 5 is a perspective view of a housing according to an embodiment;

FIG. 6 is a perspective view of a fixing structure according to an embodiment;

FIG. 7 is a perspective view of a first restriction structure according to an embodiment;

FIG. 8 is a perspective view of a second restriction structure according to an embodiment; and

FIG. 9 is a cross-sectional perspective view for describing a connection relationship of a header according to an embodiment.

### DETAILED DESCRIPTION OF THE INVENTION

Hereinafter, embodiments of the present invention will be described with reference to the drawings. In the following description, as an example of a carbon dioxide recovery apparatus 1, an apparatus applied to a direct air capture (DAC) for recovering carbon dioxide in the atmosphere in order to lower the concentration of carbon dioxide in the atmosphere will be described. For example, the carbon dioxide that has been recovered by the carbon dioxide recovery apparatus 1 is stored in the ground or is reused as a fuel or a material.

In the following description, expressions indicating relative or absolute arrangements, for example, “parallel”, “orthogonal”, “center”, and “coaxial” not only strictly mean such arrangements but also include a state of being relatively displaced with a tolerance, or an angle or a distance at which the same function is obtainable. In the drawings for use in the following description, the scale of each member is appropriately changed in order to make each member recognizable in size.

### Carbon Dioxide Recovery Apparatus

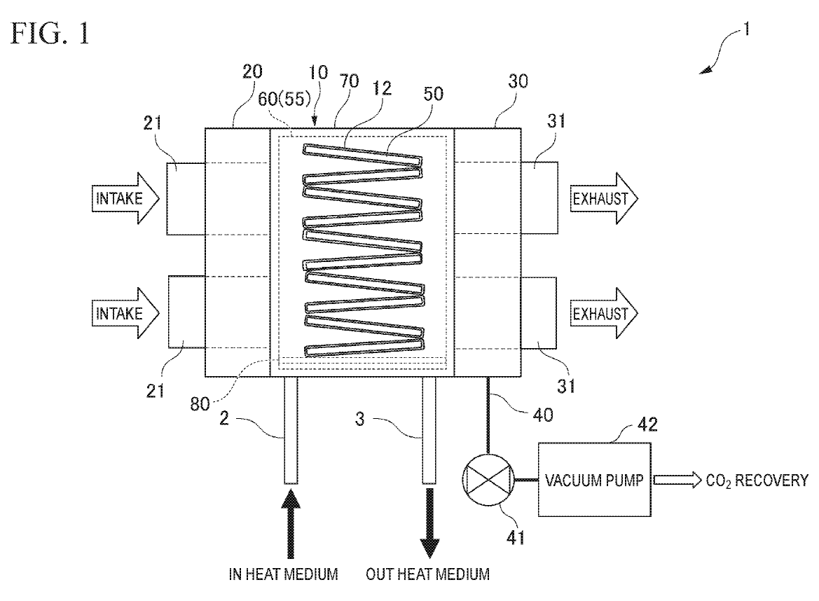

FIG. 1 is a schematic diagram of the carbon dioxide recovery apparatus 1 according to an embodiment.

As illustrated in FIG. 1, the carbon dioxide recovery apparatus 1 includes a recovery apparatus main body 10, an intake unit 20, an exhaust unit 30, a recovery line 40, a recovery valve 41, and a vacuum pump 42.

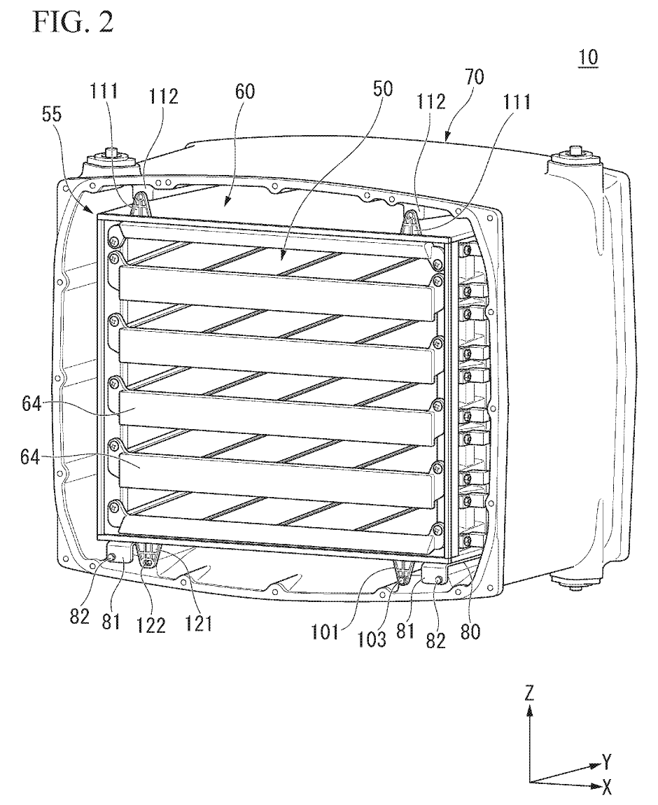

FIG. 2 is a perspective view illustrating a state in which the intake unit 20 and the exhaust unit 30 are removed, in the carbon dioxide recovery apparatus 1 according to an embodiment.

Referring also to FIG. 2, the recovery apparatus main body 10 includes: a heat exchanger 50, which holds an adsorbent 12; a support structure 60, which is constituted to be capable of supporting the heat exchanger 50; a housing 70, which is constituted to be capable of accommodating an assembly 55 with the heat exchanger 50 supported by the support structure 60; and a slide member 80, which is disposed between the assembly 55 and the housing 70, and which is constituted to make the assembly 55 slidable in a direction of inserting the assembly 55 into the housing 70.

In the following description, an orthogonal coordinate system of X, Y, and Z will be used, as necessary. X direction corresponds to a width direction (a left-right direction) of the recovery apparatus main body 10. Y direction corresponds to a depth direction (a front-rear direction) of the recovery apparatus main body 10. Z direction corresponds to a height direction (an up-down direction), which is orthogonal to X direction and Y direction, of the recovery apparatus main body 10. In the following description, in X direction, Y direction, and Z direction, an arrow in the drawing will indicate a plus (+) side, and a side opposite to the arrow will be referred to as a minus (-) side. +Z side corresponds to an upper side in the vertical direction, and -Z side corresponds to a lower side in the vertical direction.

For example, the heat exchanger 50 is a radiator. Fins are formed on the outer surface of the heat exchanger 50. A flow channel through which a heat medium circulates is formed inside the heat exchanger 50. A heat medium having a potential temperature corresponding to a step (for example, an adsorption step or a desorption step) to be performed in the recovery apparatus main body 10 is introduced into the heat exchanger 50.

First, the heat medium is introduced into the heat exchanger 50 inside the housing 70 of the recovery apparatus main body 10 through an inflow line 2. Then, the heat medium is subjected to heat exchange inside the heat exchanger 50. Then, the heat medium is returned to the outside of the housing 70 through an outflow line 3.

For example, when the desorption step is performed, a high-temperature heat medium (a heat medium having a temperature equal to or higher than a predetermined temperature) for raising the temperature of the adsorbent 12 is supplied to the heat exchanger 50. This raises the temperature of the adsorbent 12.

On the other hand, when the adsorption step is performed, a low-temperature heat medium (a heat medium having a temperature lower than a predetermined temperature) is supplied to the heat exchanger 50. This cools the adsorbent 12.

The heat exchanger 50 functions as an adsorbent holder, which holds the adsorbent 12. The adsorbent 12 is disposed in the heat exchanger 50. For example, the adsorbent 12 may be filled between the fins formed on the outer surface of the heat exchanger 50. The adsorbent 12 is heated or cooled by exchanging heat with a heat medium circulating through the flow channel inside the heat exchanger 50.

For example, the adsorbent 12 is a particulate member. The adsorbent 12 may have a carbon dioxide adsorbing property at a low temperature (for example, in a range between -30 degrees Celsius or higher and lower than 50 degrees Celsius). The adsorbent 12 may have a carbon dioxide desorbing (releasing) property at a high temperature (for example, in a range 50 degrees Celsius or higher and lower than 110 degrees Celsius) and in a state in which the concentration of carbon dioxide in the surroundings is equal to or lower than a predetermined concentration. Examples of the adsorbent 12 having such properties include a solid amine carbon dioxide adsorbent composed by carrying an amine on a porous material such as silica. Note that a mode of the adsorbent 12 is not limited to the above and can be changed in accordance with a design specification.

The recovery apparatus main body 10 is constituted to be capable of alternately performing the adsorption step of adsorbing carbon dioxide in a gas such as the atmospheric air that has been sucked into the adsorbent 12 and the desorption step of desorbing the carbon dioxide that has been adsorbed into the adsorbent 12 by heating under reduced pressure after being brought into a vacuum state.

The intake unit 20 has a function of introducing air containing carbon dioxide into the housing 70 of the recovery apparatus main body 10. The intake unit 20 includes an intake valve 21. The intake valve 21 is controlled to be in an open state in the adsorption step. The intake valve 21 is controlled to be in a closed state in the desorption step. A plurality of the intake valves 21 may be provided.

The exhaust unit 30 has a function of sending the air, which has been introduced into the inside in the adsorption step, and in which carbon dioxide has been captured by the adsorbent 12, to the outside of the housing 70. The exhaust unit 30 includes an exhaust valve 31. The exhaust valve 31 is controlled to be in the open state in the adsorption step. The exhaust valve 31 is controlled to be in the closed state in the desorption step. A plurality of exhaust valves 31 may be provided.

The recovery line 40 denotes piping having a function of sending the carbon dioxide that has been desorbed from the adsorbent 12 in the desorption step to a carbon dioxide tank, not illustrated. The recovery line 40 is connected with the exhaust unit 30. Note that the recovery line 40 is not limited to being connected with the exhaust unit 30. For example, the recovery line 40 may be connected with the intake unit 20.

The recovery valve 41 is disposed partway the recovery line 40 (for example, a part closer to the housing 70 than to the carbon dioxide tank). Note that the recovery valve 41 may be disposed at a connection portion between the recovery line 40 and the housing 70. In the desorption step for recovering carbon dioxide, the recovery valve 41 is controlled to be in an open state in which the inside of the housing 70 communicates with the inside of the recovery line 40. On the other hand, in the adsorption step, the recovery valve 41 is controlled to be in a closed state in which the inside of the housing 70 is isolated from the inside of the recovery line 40.

The vacuum pump 42 is disposed partway the recovery line 40 (for example, a part closer to the carbon dioxide tank than to the recovery valve). By driving the vacuum pump 42, the carbon dioxide that has been desorbed in the desorption step is recovered in a carbon dioxide tank (not illustrated) through the recovery line 40.

### Assembly

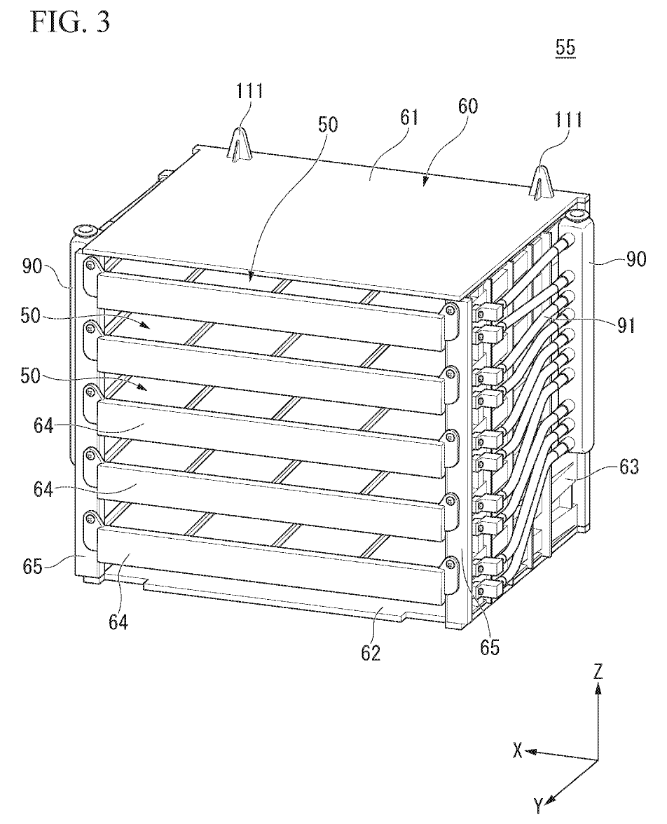

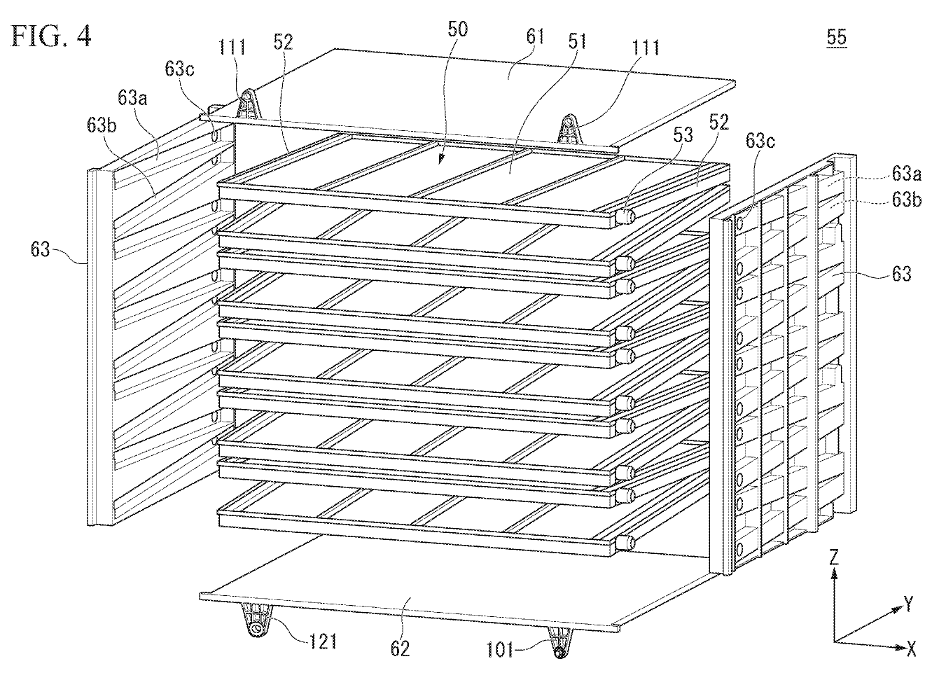

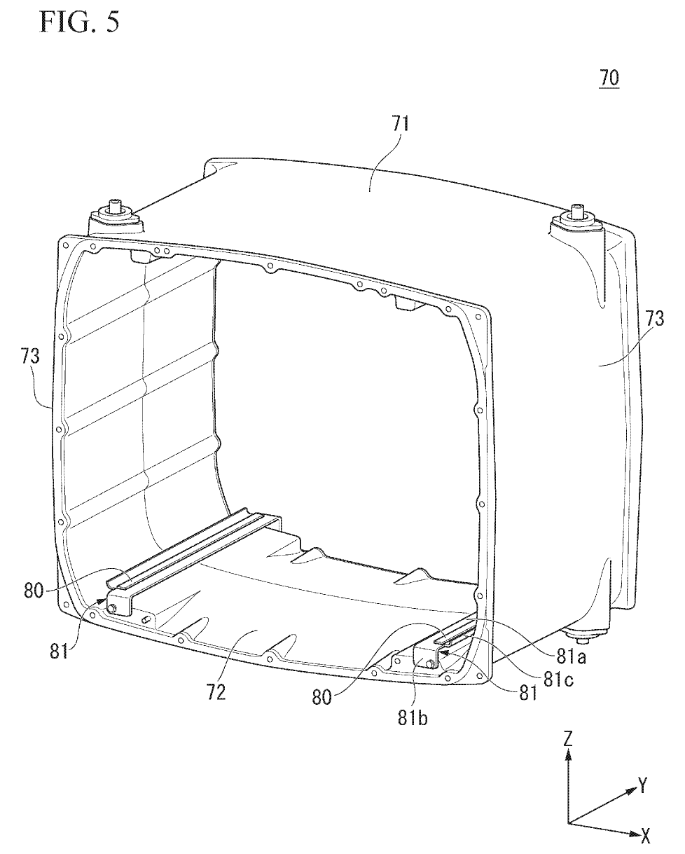

FIG. 3 is a perspective view of the assembly 55 according to an embodiment. FIG. 4 is an exploded perspective view of the assembly 55 according to an embodiment. FIG. 5 is a perspective view of the housing 70 according to an embodiment.

Referring also to FIGS. 3 to 5, the assembly 55 is a subassembly with the heat exchanger 50 supported by the support structure 60. The heat exchanger 50 is constituted to be detachable from the support structure 60.

The recovery apparatus main body 10 further includes a header 90, which is disposed inside the housing 70, and which is for circulating the heat medium into the heat exchanger 50. Two headers 90 are disposed. The inflow line 2 is connected with one of the two headers 90. The outflow line 3 is connected with the other one of the two headers 90.

The support structure 60 includes a top plate portion 61, a bottom plate portion 62, side plate portions 63, and horizontal plate portions 64. The top plate portion 61, the bottom plate portion 62, the side plate portions 63, and the horizontal plate portions 64 function as support portions for supporting the heat exchanger 50. The top plate portion 61, the bottom plate portion 62, the side plate portions 63, and the horizontal plate portions 64 also function as air guides for guiding the air flow.

The top plate portion 61 is made of resin, for example. The top plate portion 61 is disposed on an upper side in the height direction of the assembly 55. The top plate portion 61 is disposed above the heat exchanger 50 in the height direction of the assembly 55 (on an uppermost side in the height direction of the assembly 55). The top plate portion 61 is formed in a plate shape along a horizontal plane (XY plane).

The bottom plate portion 62 is made of resin, for example. The bottom plate portion 62 is disposed at a lower side in the height direction of the assembly 55. The bottom plate portion 62 is disposed below the heat exchanger 50 in the height direction of the assembly 55 (on a lowermost side in the height direction of the assembly 55). The bottom plate portion 62 is formed in a plate shape along the horizontal plane.

The side plate portion 63 is made of resin, for example. The side plate portion 63 is disposed on an outer side in the width direction of the assembly 55. The side plate portion 63 is disposed on an outer side of the heat exchanger 50 in the width direction of the assembly 55 (on an outermost side in the width direction of the assembly 55). The side plate portion 63 is formed in a plate shape along a vertical plane (YZ plane). A pair of left and right side plate portions 63 are disposed interposing the heat exchanger 50 between them.

One of an upper end portion of the side plate portion 63 and an outer end portion of the top plate portion 61 in the width direction may be constituted to be capable of fitting into the other one of them. One of a lower end portion of the side plate portion 63 and an outer end portion of the bottom plate portion 62 in the width direction may be constituted to be capable of fitting into the other one of them. With such fitting structures, it becomes possible to simplify the assembly, as compared with a structure for fixing with a bolt or the like. In addition, the number of component parts can be reduced, and the weight can be reduced, as compared with the structure for fixing with a bolt or the like.

The horizontal plate portion 64 is made of resin, for example. The horizontal plate portion 64 is disposed on an outer side in the depth direction of the assembly 55. The horizontal plate portion 64 is disposed on an outer side of the heat exchanger 50 in the depth direction of the assembly 55 (on an outermost side in the depth direction of the assembly 55). The horizontal plate portion 64 is formed in a plate shape extending in the width direction. The horizontal plate portions 64 are disposed on the front of and back of the heat exchanger 50. A plurality of horizontal plate portions 64 are disposed up and down on the front and back of the heat exchanger 50. An outer end portion in the width direction of the horizontal plate portion 64 is fixed to an outer end portion in the depth direction of the side plate portion 63 with a bolt or the like.

Note that a plate portion that constitutes the support structure 60 is not limited to being made of resin. For example, the plate portion that constitutes the support structure 60 may be made of metal such as aluminum. For example, the plate portion that constitutes the support structure 60 may include a mesh structure (for example, a wire mesh structure) made of metal such as stainless steel (SUS). For example, the plate portion that constitutes the support structure 60 may be constituted by combining a metal mesh structure with a resin frame member. Note that a constitution mode of the support structure 60 is not limited to the above and can be changed in accordance with a design specification.

A seal member 65, which is made of, for example, a foamable material, may be provided on an outer end portion in the depth direction of the side plate portion 63, which constitutes the support structure 60. The horizontal plate portion 64 may be fixed to the side plate portion 63 with a bolt via the seal member 65. Thus, the seal member 65 is sandwiched between the side plate portion 63 and the horizontal plate portion 64 and is deformed correspondingly, and a gap between the side plate portion 63 and the horizontal plate portion 64 is closed.

The assembly 55 has a structure that can be disassembled while being detached from the housing 70. When the top plate portion 61, the bottom plate portion 62, the side plate portions 63, and the horizontal plate portions 64 are removed from the assembly 55, it becomes possible to take out the heat exchanger 50 and replace the adsorbent 12.

The side plate portion 63 includes recess portions 63a and 63b, which are formed to be capable of accommodating end portions of the heat exchanger 50. The recess portions 63a and 63b are formed on an inner surface, which faces the heat exchanger 50, of the side plate portion 63. The recess portions 63a and 63b are each formed in a groove shape that conforms to the shapes of the end portions of the heat exchanger 50. Note that the recess portions 63a and 63b each may be formed to be a recess portion with its periphery formed in a protrusion shape.

A plurality of recess portions 63a and 63b are disposed. The plurality of recess portions 63a and 63b are disposed to make a pair of an upper one and a lower one. The recess portions 63a and 63b are disposed to correspond to the number of heat exchangers 50 to be accommodated. The plurality of recess portions 63a and 63b are formed in a comb-teeth shape in a side view when viewed from the width direction. In the illustrated example, five pairs of recess portions 63a and 63b are aligned in the up-down direction. The side plate portion 63 is constituted to be capable of accommodating ten heat exchangers 50 in total.

The recess portion 63a, which is one of the recess portions 63a and 63b making a pair of an upper one and a lower one, is inclined to be positioned further on -Z side from a -Y end toward a +Y end of the side plate portion 63 in the side view when viewed from the width direction. The recess portion 63b, which is the other one of them, is inclined to be positioned further on +Z side from the -Y end toward the +Y end of the side plate portion 63 in the side view when viewed from the width direction. The recess portions 63a and 63b making the pair of the upper one and the lower one are disposed in a letter V shape in which a space between -Y ends is wider than a space between +Y ends in the side plate portion 63 in the side view when viewed from the width direction.

A connection through hole 63c for connecting a flow channel connection portion 53 of the heat exchanger 50 with the header 90 is formed on the side plate portion 63. The connection through hole 63c is formed at an end portion in the longitudinal direction of each of the plurality of recess portions 63a and 63b.

The heat exchanger 50 includes a heat exchange main body portion 51, an insertion portion 52, and the flow channel connection portion 53.

The heat exchange main body portion 51 is formed in a rectangular parallelepiped shape. A flow channel through which the heat medium circulates is formed inside the heat exchange main body portion 51.

The insertion portions 52 are formed on both ends in the width direction of the heat exchange main body portion 51. The insertion portion 52 is a part to be inserted (accommodated) into each of the recess portions 63a and 63b in the heat exchanger 50.

The flow channel connection portion 53 is a part for connecting a flow channel formed inside the heat exchange main body portion 51 with a flow channel in connection with the header 90. The flow channel connection portion 53 is formed on one end in the depth direction in each of the insertion portions 52 on the left and right sides of the heat exchange main body portion 51. The flow channel connection portion 53 is different in position for every one of the left and right insertion portions 52. In a state in which the end portions (the insertion portions 52) of the heat exchanger 50 are accommodated in the recess portions 63a and 63b of the side plate portion 63, the flow channel connection portion 53 is connected with the header 90 through the connection through hole 63c. The flow channel connection portion 53 is connected with the header 90 via a pipe 91 or the like.

### Housing

Referring also to FIG. 5, the housing 70 is constituted to be capable of accommodating the assembly 55 with the heat exchanger 50 supported by the support structure 60. The housing 70 is made of metal such as aluminum, for example. The housing 70 includes: an upper wall portion 71 and a lower wall portion 72, which are disposed to be spaced apart from each other in the up-down direction; and side wall portions 73, which are disposed to be spaced apart from each other in the width direction. The housing 70 is formed in a tubular shape that opens in the depth direction. The housing 70 is integrally formed by molding, for example.

The housing 70 is formed in a shape curved outward in each the height direction and the width direction. Such a curved shape enables stress due to vacuum pressure to be released. In addition, by integrally forming the housing 70 by molding, it becomes possible to achieve both a mold-removing direction and negative pressure strength.

Note that the housing 70 may not necessarily have the above-described curved shape. For example, the housing 70 may be formed in a rectangular tubular shape. For example, the housing 70 may include a pair of upper and lower plate members along XY plane, and a pair of left and right plate members along YZ plane. Note that the shape of the housing 70 is not limited to the above and can be changed in accordance with a design specification.

### Slide Member

The slide member 80 is disposed between the assembly 55 and the housing 70. The slide member 80 is constituted to make the assembly 55 slidable in a direction of inserting the assembly 55 into the housing 70.

The slide member 80 is made of a material having a sliding property higher than that of the material of the housing 70. The slide member 80 is made of a material having a heat insulation property higher than that of the material of the housing 70. The slide member 80 is made of resin, for example. The slide member 80 is preferably made of a fluororesin (an example of a low-friction material) such as polytetrafluoroethylene (PTFE).

A pair of slide members 80 are disposed on both outer sides in the width direction of the housing 70. The slide member 80 is disposed on an upper surface of a bracket 81, which is attached to the housing 70. The slide member 80 is formed in a sheet shape along the upper surface of the bracket 81. The bracket 81 includes: a rail portion 81a, which extends in the depth direction; a coupling portion 81b, which extends downward from both ends in Y direction of the rail portion 81a; and a curved portion 81c, which is curved upward from an outer end in X direction of the rail portion 81a. The coupling portion 81b of the bracket 81 is fixed to the lower wall portion 72 of the housing 70 with a bolt. The curved portion 81c has a function of guiding the assembly 55 in a direction of inserting the assembly 55 into the housing 70.

### Fixing Structure

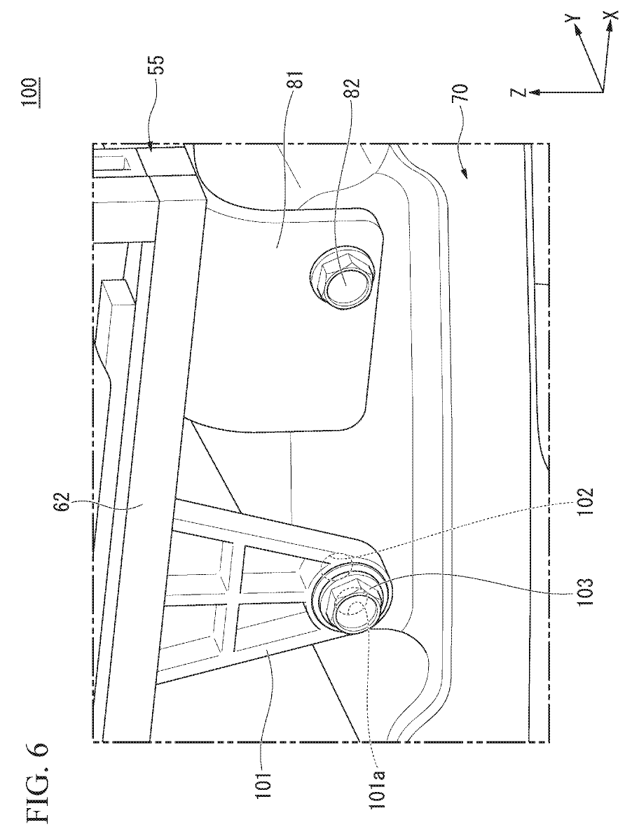

FIG. 6 is a perspective view of a fixing structure 100 according to an embodiment.

Referring also to FIG. 6, the recovery apparatus main body 10 further includes the fixing structure 100, which is disposed between the assembly 55 and the housing 70, and which is for fixing the assembly 55 and the housing 70. In the illustrated example, the fixing structure 100 fixes the assembly 55 to the housing 70 with one bolt.

The fixing structure 100 includes: a fixing protrusion portion 101, which protrudes from the assembly 55 toward the housing 70, and in which a screw hole 101a is formed; a female screw portion 102, which is provided in the housing 70; and a male screw 103, which is screwed into the female screw portion 102 through the screw hole 101a.

The fixing protrusion portion 101 protrudes downward from a part close to a +X end, in a -Y end portion of the bottom plate portion 62, which constitutes the assembly 55. The fixing protrusion portion 101 is formed in a letter V shape in which a left-right width at a +Z end is wider than the left-right width at a -Z end when viewed from the depth direction of the assembly 55. The fixing protrusion portion 101 may include a reinforcement rib. The screw hole 101a penetrates through a part in a tip end (a lower end) of the fixing protrusion portion 101 in the depth direction of the assembly 55.

The female screw portion 102 is provided at a part close to a +X end, on a -Y end side of the lower wall portion 72 of the housing 70. The fixing structure 100 for fixing the assembly 55 and the housing 70, and one fastening portion 82 of the pair of slide members 80 are disposed on the same side in the width direction of the housing 70. The female screw portion 102, which constitutes the fixing structure 100, is disposed further on -X side than the fastening portion 82 of the bracket 81 on which the slide member 80 on +X side is disposed. In the illustrated example, the assembly 55 is fixed to the housing 70 with one male screw 103 (fixed with one bolt).

### First Restriction Structure

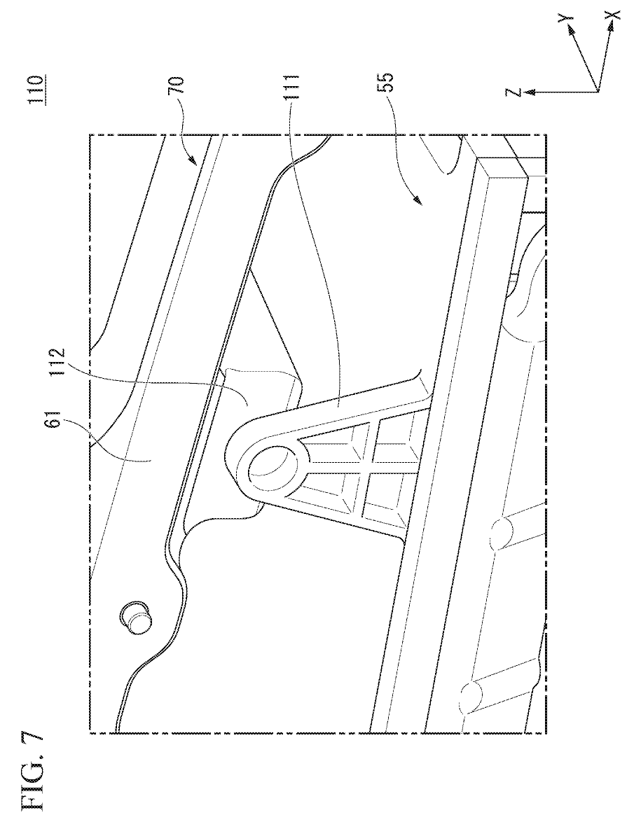

FIG. 7 is a perspective view of a first restriction structure 110 according to an embodiment.

Referring also to FIG. 7, the recovery apparatus main body 10 further includes the first restriction structure 110, which is disposed between the assembly 55 and the housing 70, and which restricts a displacement of the assembly 55 in the insertion direction. In the illustrated example, when the assembly 55 is inserted into the housing 70 in +Y direction, the first restriction structure 110 restricts a displacement of the assembly 55 in +Y direction at an insertion completed position.

The fixing structure 100 and the first restriction structure 110 for fixing the assembly 55 and the housing 70 are disposed on opposite sides to each other in the height direction of the housing 70. In the illustrated example, the fixing structure 100 is disposed to be close to a lower end in the height direction of the housing 70. On the other hand, the first restriction structure 110 is disposed to be close to an upper end in the height direction of the housing 70.

The first restriction structure 110 includes: a first restriction protrusion portion 111, which protrudes from the assembly 55 toward the housing 70; and an abutment portion 112, which is disposed on the housing 70, and which abuts the first restriction protrusion portion 111 in the insertion direction.

The first restriction protrusion portion 111 protrudes upward from a part close to an outer end in X direction, in a -Y end portion of the top plate portion 61, which constitutes the assembly 55. The first restriction protrusion portion 111 is formed in a letter V shape (an inverted letter V shape) in which the left-right width at a -Z end is wider than the left-right width at a +Z end when viewed from the depth direction of the assembly 55. The first restriction protrusion portion 111 may include a reinforcement rib. Two first restriction protrusion portions 111 in total are disposed to be spaced apart from each other in X direction.

The abutment portion 112 is provided at a part close to an outer end in X direction, on a -Y end side of the upper wall portion 71 of the housing 70. The abutment portion 112 is formed in a protrusion shape including a surface that overlaps a part in a tip end (an upper end) of the first restriction protrusion portion 111 when viewed from the depth direction of the assembly 55. The abutment portion 112 is not fixed to the first restriction protrusion portion 111. Two abutment portions 112 in total are disposed to be spaced apart from each other in X direction.

### Second Restriction Structure

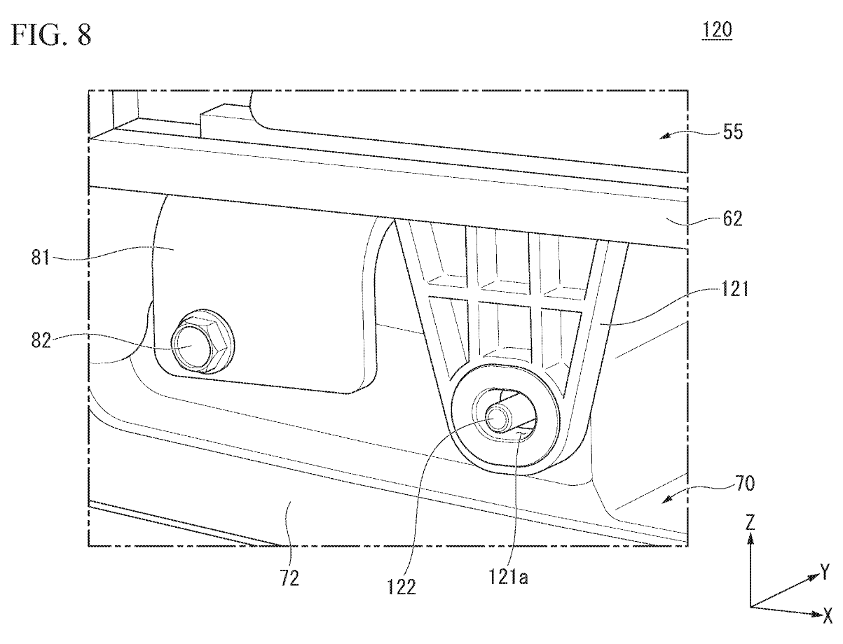

FIG. 8 is a perspective view of a second restriction structure 120 according to an embodiment.

Referring also to FIG. 8, the recovery apparatus main body 10 further includes the second restriction structure 120, which is disposed between the assembly 55 and the housing 70, and which restricts a displacement of the assembly 55 in a direction that intersects the insertion direction. In the illustrated example, when the assembly 55 is inserted into the housing 70 in +Y direction, the second restriction structure 120 absorbs a dimensional change (thermal deformation) of the assembly 55 in each direction at the insertion completed position and also restricts a displacement of a predetermined amount or more of the assembly 55 in each direction.

The fixing structure 100 and the second restriction structure 120 for fixing the assembly 55 and the housing 70 are disposed on opposite sides to each other in the width direction of the housing 70. In the illustrated example, the fixing structure 100 is disposed to be close to a +X end in the width direction of the housing 70. On the other hand, the second restriction structure 120 is disposed to be close to a -X end in the width direction of the housing 70.

The second restriction structure 120 includes: a second restriction protrusion portion 121, which protrudes from the assembly 55 toward the housing 70, and in which a long hole 121a is formed; and a pin 122, which is disposed on the housing 70, and which is inserted into the long hole 121a.

The second restriction protrusion portion 121 protrudes downward from a part close to a -X end, in a -Y end portion of the bottom plate portion 62, which constitutes the assembly 55. The second restriction protrusion portion 121 is formed in a letter V shape in which the left-right width at a +Z end is wider than the left-right width at a -Z end when viewed from the depth direction of the assembly 55. The second restriction protrusion portion 121 may include a reinforcement rib. The long hole 121a extends in the width direction in a part in a tip end (a lower end) of the second restriction protrusion portion 121 and also penetrates into the assembly 55 in the depth direction.

The pin 122 is provided at a part close to a -X end, on a -Y end side of the lower wall portion 72 of the housing 70. The second restriction structure 120 and the other fastening portion 82 of the pair of slide members 80 are disposed on the same side in the width direction of the housing 70. The pin 122, which constitutes the second restriction structure 120, is disposed further on +X side than the fastening portion 82 of the bracket 81 on which the slide member 80 on -X side is disposed. In the illustrated example, the assembly 55 is aligned with the housing 70 with a single pin 122.

### Connection Relationship of Header

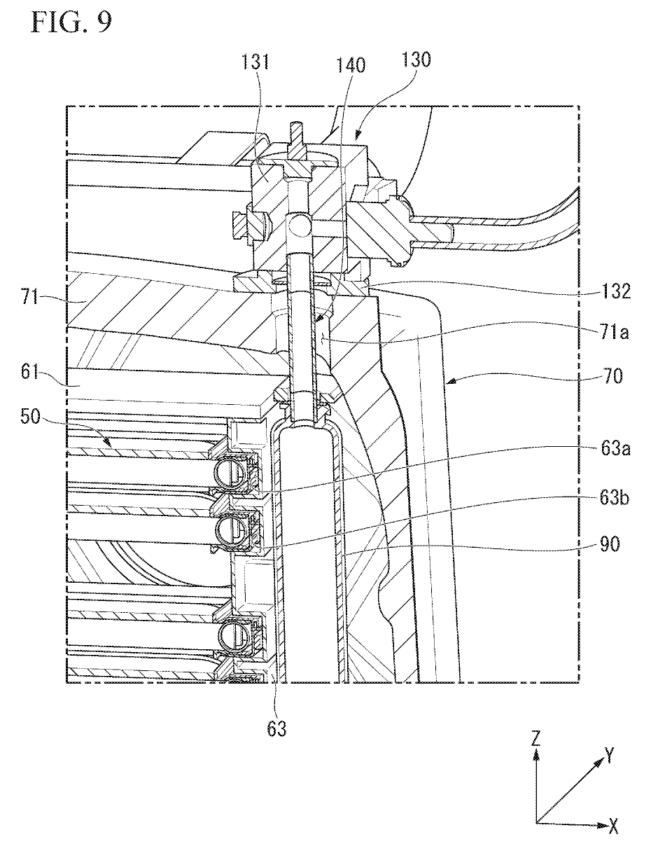

FIG. 9 is a cross-sectional perspective view for describing a connection relationship of a header according to an embodiment.

Referring also to FIG. 9, the recovery apparatus main body 10 further includes: a circulation structure 130, which is disposed outside the housing 70, and which is for flowing the heat medium; and piping 140, which penetrates into the housing 70 to communicate the inside of the circulation structure 130 with the inside of the header 90 to circulate the heat medium into the header 90.

The circulation structure 130 denotes a structure for circulating the heat medium into the heat exchanger 50, which is supported by the support structure 60. Note that the circulation structure 130, which is close to the header 90 in connection with the inflow line 2, may be common to the circulation structure 130, which is close to the header 90 in connection with the outflow line 3.

The circulation structure 130 includes a circulation main body portion 131, with which the inflow line 2 or the outflow line 3 is connected. The circulation main body portion 131 is disposed outside the housing 70. A flow channel through which the heat medium in the inflow line 2 or the outflow line 3 circulates is formed inside the circulation main body portion 131. A seal member 132 is disposed between the circulation main body portion 131 and the housing 70. In the illustrated example, the circulation main body portion 131 is connected with an end portion of the upper wall portion 71 of the housing 70 through the seal member 132.

The piping 140 has flexibility. The piping 140 is made of a material softer than the material of the housing 70. The piping 140 is made of resin, for example.

A hole 71a, which penetrates in the up-down direction, is formed in the upper wall portion 71 of the housing 70. The piping 140 extends in the up-down direction through the hole 71a of the upper wall portion 71 of the housing 70. An upper end portion of the piping 140 is connected with a lower end portion of the circulation main body portion 131. A lower end portion of the piping 140 is connected with an upper end portion of the header 90.

An outer diameter of the piping 140 is smaller than an inner diameter of the hole 71a of the upper wall portion 71. A gap is formed between an inner circumferential surface of the hole 71a of the upper wall portion 71 and an outer circumferential surface of the piping 140. By forming an air layer in such a gap, heat transfer from the piping 140 to the housing 70 can be suppressed.

### Operation and Effects

As described heretofore, the carbon dioxide recovery apparatus 1 according to the above embodiment includes: the heat exchanger 50, which holds the adsorbent 12; the support structure 60, which is constituted to be capable of supporting the heat exchanger 50; the housing 70, which is constituted to be capable of accommodating the assembly 55 with the heat exchanger 50 supported by the support structure 60; and the slide member 80, which is disposed between the assembly 55 and the housing 70, and which is constituted to make the assembly 55 slidable in a direction of inserting the assembly 55 into the housing 70.

According to this constitution, it becomes possible to accommodate, in the housing 70, the assembly 55 in which the heat exchanger 50 is supported by the support structure 60. In addition, the slide member 80 makes the assembly 55 slidable in the direction of inserting the assembly 55 into the housing 70. Thus, it becomes possible to achieve assembly work of the carbon dioxide recovery apparatus 1 in a simple constitution in which the heat exchanger 50 is supported by the support structure 60 to form the assembly 55 (a subassembly), and the assembly 55 is made to slide in the housing 70. This constitution eliminates the need for inserting and fixing another guide member in assembling the heat exchanger, after the heat exchanger is inserted along the guide member, which is attached to the case. Therefore, it becomes possible to reduce the number of assembling steps of the carbon dioxide recovery apparatus 1. In addition, this contributes to mitigating climate change or reducing its influence, accordingly.

In the above embodiment, the slide member 80 is made of a material having a sliding property higher than that of the material of the housing 70.

According to this constitution, it becomes possible to make the assembly 55 slide more smoothly than a case where the slide member 80 is made of a material having a sliding property equal to or lower than that of the housing 70.

In the above embodiment, the slide member 80 is made of a material having a heat insulation property higher than that of the material of the housing 70.

According to this constitution, it becomes possible to further enhance the heat insulation property between the assembly 55 and the housing 70, as compared with a case where the slide member 80 is made of a material having a heat insulation property equal to or lower than that of the material of the housing 70.

In the above embodiment, the carbon dioxide recovery apparatus 1 further includes the fixing structure 100, which is disposed between the assembly 55 and the housing 70, and which is for fixing the assembly 55 and the housing 70.

According to this constitution, it becomes possible to fix the assembly 55 and the housing 70 using the fixing structure 100.

In the above embodiment, the fixing structure 100 includes: the fixing protrusion portion 101, which protrudes from the assembly 55 toward the housing 70, and in which the screw hole 101a is formed; the female screw portion 102, which is provided in the housing 70; and the male screw 103, which is screwed into the female screw portion 102 through the screw hole 101a.

According to this constitution, the male screw 103 is screwed into the female screw portion 102 in the housing 70 through the screw hole 101a of the fixing protrusion portion 101 on the assembly 55, and thus it becomes possible to fix the assembly 55 and the housing 70.

In the above embodiment, the carbon dioxide recovery apparatus 1 further includes the first restriction structure 110, which is disposed between the assembly 55 and the housing 70, and which restricts a displacement of the assembly 55 in the insertion direction.

According to this constitution, the first restriction structure 110 is capable of restricting a displacement of (positioning) the assembly 55 in the direction of inserting the assembly 55 into the housing 70.

In the above embodiment, the fixing structure 100 for fixing the assembly 55 and the housing 70, and the first restriction structure 110 are disposed on opposite sides to each other in the height direction of the housing 70.

According to this constitution, it becomes possible to fix and position the assembly 55 and the housing 70 more stably than a case where the fixing structure 100 and the first restriction structure 110 are disposed on the same side in the height direction of the housing 70.

In the above embodiment, the first restriction structure 110 includes: the first restriction protrusion portion 111, which protrudes from the assembly 55 toward the housing 70; and the abutment portion 112, which is disposed on the housing 70, and which abuts the first restriction protrusion portion 111 in the insertion direction.

According to this constitution, the abutment portion 112 on the housing 70 is brought into contact with the first restriction protrusion portion 111 on the assembly 55, and thus it becomes possible to restrict the displacement of (position) the assembly 55 in the direction of inserting the assembly 55 into the housing 70.

In the above embodiment, the carbon dioxide recovery apparatus 1 further includes: the second restriction structure 120, which is disposed between the assembly 55 and the housing 70, and which restricts the displacement of the assembly 55 in the direction that intersects the insertion direction.

According to this constitution, the second restriction structure 120 is capable of restricting a displacement of (positioning) the assembly 55 in the intersecting direction, in inserting the assembly 55 into the housing 70.

In the above embodiment, the fixing structure 100 for fixing the assembly 55 and the housing 70, and the second restriction structure 120 are disposed on opposite sides to each other in the width direction of the housing 70.

According to this constitution, it becomes possible to fix and position the assembly 55 and the housing 70 more stably than a case where the fixing structure 100 and the second restriction structure 120 are disposed on the same side in the width direction of the housing 70.

In the above embodiment, the second restriction structure 120 includes: the second restriction protrusion portion 121, which protrudes from the assembly 55 toward the housing 70, and in which the long hole 121a is formed; and the pin 122, which is disposed on the housing 70, and which is inserted into the long hole 121a.

According to this constitution, by inserting the pin 122 on the housing 70 into the long hole 121a of the second restriction protrusion portion 121 on the assembly 55, it becomes possible to restrict the displacement of (position) the assembly 55 in the intersecting direction, in inserting the assembly 55 into the housing 70.

In the above embodiment, the support structure 60 includes the side plate portion 63, which is disposed on an outer side in the width direction of the assembly 55, and which includes the recess portions 63a and 63b formed to be capable of accommodating the end portions of the heat exchanger 50.

According to this constitution, the end portions of the heat exchanger 50 are accommodated in the recess portions 63a and 63b of the side plate portion 63 of the support structure 60, and thus the assembly 55 can be formed.

In the above embodiment, the recess portions 63a and 63b are each formed in a groove shape that conforms to the shape of the end portion of the heat exchanger 50.

According to this constitution, the end portions of the heat exchanger 50 are accommodated in the recess portions 63a and 63b, each of which is formed in a groove shape that conforms to the shape of the end portion of the heat exchanger 50, so that the heat exchanger 50 can be positioned with respect to the side plate portion 63 of the support structure 60. This eliminates the need for a separate member for positioning the heat exchanger, so that the assembly 55 can be simplified.

In the above embodiment, the carbon dioxide recovery apparatus 1 further includes the header 90, which is disposed inside the housing 70, and which is for circulating the heat medium into the heat exchanger 50.

According to this constitution, heat radiation from the header 90 to the outside air can be reduced as compared with a case where the header 90 is provided outside the housing 70. Accordingly, heat loss can be reduced.

In the above embodiment, the carbon dioxide recovery apparatus 1 further includes: the circulation structure 130, which is disposed outside the housing 70, and which is for flowing the heat medium; and the piping 140, which penetrates into the housing 70 to communicate the inside of the circulation structure 130 with the inside of the header 90 to circulate the heat medium into the header 90.

According to this constitution, the piping 140, which penetrates into the housing 70, enables the inside of the circulation structure 130 in the outside of the housing 70 and the inside of the header 90 in the inside of the housing 70 to communicate with each other. Thus, escaping of the heat of the heat medium to the housing 70 can be suppressed.

In the above embodiment, the piping 140 has flexibility.

According to this constitution, thermal expansion of the housing 70 and the header 90 can be absorbed by the piping 140 having flexibility.

In the above embodiment, a pair of slide members 80 are disposed on both outer sides in the width direction of the housing 70.

According to this constitution, the assembly 55 is capable of sliding more stably than a case where the slide member 80 is disposed on only one outer side in the width direction of the housing 70.

In the above embodiment, the fixing structure 100 for fixing the assembly 55 and the housing 70, and one fastening portion 82 of the pair of slide members 80 are disposed on the same side in the width direction of the housing 70.

According to this constitution, fixing with the fixing structure 100 and fastening of one of the slide members 80 can be conducted on the same side in the width direction of the housing 70.

In a constitution in which the heat exchanger for heating and cooling the adsorbent is provided as the adsorbent holder, by the way, it is necessary to detach the heat exchanger from the housing in order to replace the adsorbent. In the work of detaching the heat exchanger, it is necessary to detach not only the heat exchanger but also other assembly components. In addition, in the case of a constitution in which a plurality of heat exchangers each including the adsorbent are accommodated in the up-down direction, it is necessary to stack the heat exchangers one by one from a lower layer of the housing. In this manner, the work of attaching and detaching the heat exchanger in the related art takes labor.

On the other hand, in the above embodiment, it becomes possible to achieve assembly work of the carbon dioxide recovery apparatus 1 in a simple constitution in which the heat exchanger 50 is supported by the support structure 60 to form the assembly 55 (a subassembly), and the assembly 55 is made to slide in the housing 70. This constitution eliminates the need for inserting and fixing another guide member in assembling the heat exchanger, after the heat exchanger is inserted along the guide member, which is attached to the case. In addition, also in the case of a constitution in which a plurality of heat exchangers 50 each including the adsorbent 12 are accommodated in the up-down direction, there is no need to stack the heat exchangers one by one from the lower layer of the housing. Therefore, the labor taken in the work of attaching and detaching the heat exchanger can be suppressed.

In addition, in the heat exchanger, an aluminum component is brazed in some cases in consideration of the structure, and a dimensional tolerance may become equal to or larger than a predetermined value. If a dimensional error of the heat exchanger becomes equal to or larger than the predetermined value, a gap generated between the housing and the heat exchanger will become larger. Such a gap may cause a decrease in air volume passing through the adsorbent and may also cause a decrease in the carbon dioxide recovery rate.

On the contrary, in the above embodiment, the end portions of the heat exchanger 50 are accommodated in the recess portions 63a and 63b, each of which is formed in a groove shape that conforms to the shape of the end portion of the heat exchanger 50, so that the heat exchanger 50 can be positioned with respect to the side plate portion 63 of the support structure 60. This eliminates the need for a separate member for positioning the heat exchanger, so that the assembly 55 can be simplified. In addition, excessive enlargement of the gap generated between the support structure 60 and the heat exchanger 50 can be suppressed. Therefore, it becomes possible to suppress a decrease in the air volume passing through the adsorbent 12, and to suppress a decrease in the carbon dioxide recovery rate.

### Modifications

In the above embodiment, the description has been made with regard to an example in which the slide member is made of a material having a sliding property higher than that of the material of the housing, but the present invention is not limited to this. For example, the slide member may be made of a material having a sliding property equal to or lower than that of the material of the housing. The material of the slide member (the material for ensuring the sliding property) can be changed in accordance with a design specification.

In the above embodiment, the description has been made with regard to an example in which the slide member is made of a material having a heat insulation property higher than that of the material of the housing, but the present invention is not limited to this. For example, the slide member may be made of a material having a heat insulation property equal to or lower than that of the material of the housing. The material of the slide member (the material for ensuring the heat insulation property) can be changed in accordance with a design specification.

In the above embodiment, the description has been made with regard to an example in which the carbon dioxide recovery apparatus is disposed between the assembly and the housing and further includes the fixing structure for fixing the assembly and the housing, but the present invention is not limited to this. For example, the carbon dioxide recovery apparatus may not necessarily include the fixing structure. An installation mode of the fixing structure can be changed in accordance with a design specification.

In the above embodiment, the description has been made with regard to the fixing structure including: the fixing protrusion portion, which protrudes from the assembly toward the housing, and in which the screw hole is formed; the female screw portion provided in the housing; and the male screw screwed into the female screw portion through the screw hole, but the present invention is not limited to this. For example, the disposed positions of the fixing protrusion portion and the female screw portion may be reversed from the above-described ones. For example, the fixing structure may include: a fixing protrusion portion, which protrudes from the housing toward the assembly, and in which a screw hole is formed; a female screw portion provided in the assembly; and a male screw screwed into the female screw portion through the screw hole. A constitution mode of the fixing structure can be changed in accordance with a design specification.

In the above embodiment, the description has been made with regard to an example in which the carbon dioxide recovery apparatus further includes the first restriction structure, which is disposed between the assembly and the housing, and which restricts the displacement of the assembly in the insertion direction, but the present invention is not limited to this. For example, the carbon dioxide recovery apparatus may not necessarily include the first restriction structure. An installation mode of the first restriction structure can be changed in accordance with a design specification.

In the above embodiment, the description has been made with regard to an example in which the fixing structure for fixing the assembly and the housing, and the first restriction structure are disposed on opposite sides to each other in the height direction of the housing, but the present invention is not limited to this. For example, the fixing structure and the first restriction structure may be disposed on the same side in the height direction of the housing. Disposed modes of the fixing structure and the first restriction structure can be changed in accordance with a design specification.

In the above embodiment, the description has been made with regard to an example in which the first restriction structure includes: the first restriction protrusion portion that protrudes from the assembly toward the housing; and the abutment portion, which is disposed on the housing, and which abuts the first restriction protrusion portion in the insertion direction, but the present invention is not limited to this. For example, the disposed positions of the first restriction protrusion portion and the abutment portion may be reversed from the above-described ones. For example, the first restriction structure may include: a first restriction protrusion portion that protrudes from the housing toward the assembly; and an abutment portion, which is disposed on the assembly, and which abuts the first restriction protrusion portion in the insertion direction. A constitution mode of the first restriction structure can be changed in accordance with a design specification.

In the above embodiment, the description has been made with regard to an example in which the carbon dioxide recovery apparatus further includes the second restriction structure, which is disposed between the assembly and the housing, and which restricts the displacement of the assembly in the direction that intersects the insertion direction, but the present invention is not limited to this. For example, the carbon dioxide recovery apparatus may not necessarily include the second restriction structure. An installation mode of the second restriction structure can be changed in accordance with a design specification.

In the above embodiment, the description has been made with regard to an example in which the fixing structure for fixing the assembly and the housing, and the second restriction structure are disposed on the opposite sides to each other in the width direction of the housing, but the present invention is not limited to this. For example, the fixing structure and the second restriction structure may be disposed on the same side in the width direction of the housing. Disposed modes of the fixing structure and the second restriction structure can be changed in accordance with a design specification.

In the above embodiment, the description has been made with regard to an example in which the second restriction structure includes: the second restriction protrusion portion, which protrudes from the assembly toward the housing, and in which the long hole is formed; and the pin disposed on the housing and inserted into the long hole, but the present invention is not limited to this. For example, the disposed positions of the second restriction protrusion portion and the pin may be reversed from the above-described ones. For example, the second restriction structure may include: a second restriction protrusion portion, which protrudes from the housing toward the assembly, and in which a long hole is formed; and a pin disposed on the assembly and inserted into the long hole. A constitution mode of the second restriction structure can be changed in accordance with a design specification.

In the above embodiment, the description has been made with regard to an example in which the support structure includes the side plate portion, which is disposed on an outer side in the width direction of the assembly, and which includes the recess portion formed to be capable of accommodating the end portion of the heat exchanger, but the present invention is not limited to this. For example, the side plate portion may be disposed on the outer side in the width direction of the assembly and may include a protrusion portion formed to be capable of supporting the end portion of the heat exchanger. A constitution mode of the side plate portion can be changed in accordance with a design specification.

In the above embodiment, the description has been made with regard to an example in which the recess portion is formed in a groove shape that conforms to the shape of the end portion of the heat exchanger, but the present invention is not limited to this. For example, the recess portion may be formed in a shape different from the shape of the end portion of the heat exchanger. For example, another member for positioning the heat exchanger with respect to the side plate portion of the support structure may be provided. The shape of the recess portion can be changed in accordance with a design specification.

In the above embodiment, the description has been made with regard to an example in which the carbon dioxide recovery apparatus further includes the header, which is disposed inside the housing, and which is for circulating the heat medium into the heat exchanger, but the present invention is not limited to this. For example, the carbon dioxide recovery apparatus may include the header outside the housing. A disposed mode of the header can be changed in accordance with a design specification.

In the above embodiment, the description has been made with regard to the carbon dioxide recovery apparatus further including: the circulation structure, which is disposed outside the housing, and which is for flowing the heat medium; and the piping, which penetrates into the housing to communicate the inside of the circulation structure with the inside of the header to circulate the heat medium into the header, but the present invention is not limited to this. For example, the piping may not necessarily penetrate into the housing. A mode of communicating the inside of the circulation structure in the outside of the housing with the inside of the header in the inside of the housing can be changed in accordance with a design specification.

In the above embodiment, the description has been made with regard to an example in which the piping has flexibility, but the present invention is not limited to this. For example, the piping may not necessarily have the flexibility. For example, the piping may be constituted of a rigid body. A constitution mode of the piping can be changed in accordance with a design specification.

In the above embodiment, the description has been made with regard to an example in which a pair of slide members are disposed on both outer sides in the width direction of the housing, but the present invention is not limited to this. For example, the slide member may be disposed only on one outer side in the width direction of the housing. A disposed mode of the slide member can be changed in accordance with a design specification.

In the above embodiment, the description has been made with regard to an example in which the fixing structure for fixing the assembly and the housing, and one fastening portion of the pair of slide members are disposed on the same side in the width direction of the housing, but the present invention is not limited to this. For example, the fixing structure for fixing the assembly and the housing, and one fastening portion of the pair of slide members may be disposed on opposite sides to each other in the width direction of the housing. Disposed modes of the fixing structure and the fastening portion of the slide member can be changed in accordance with a design specification.

Heretofore, the modes for carrying out the present invention have been described with embodiments, but the present invention is not limited to the embodiments described above, and various modifications and substitutions can be made without departing from the gist of the present invention.

What is claimed is:

1. A carbon dioxide recovery apparatus comprising:
a heat exchanger that holds an adsorbent;
a support structure constituted to be capable of supporting the heat exchanger;
a housing constituted to be capable of accommodating an assembly with the heat exchanger supported by the support structure; and
a slide member disposed between the assembly and the housing and constituted to make the assembly slidable in an insertion direction of inserting the assembly into the housing.

2. The carbon dioxide recovery apparatus according to claim 1, wherein
the slide member is made of a material having a sliding property higher than a material of the housing.

3. The carbon dioxide recovery apparatus according to claim 1, wherein
the slide member is made of a material having a heat insulation property higher than a material of the housing.

4. The carbon dioxide recovery apparatus according to claim 1, further comprising
a fixing structure, which is disposed between the assembly and the housing, and which is for fixing the assembly and the housing.

5. The carbon dioxide recovery apparatus according to claim 4, wherein
the fixing structure includes:
a fixing protrusion portion, which protrudes from the assembly toward the housing, in which a screw hole is formed;
a female screw portion provided in the housing; and
a male screw screwed into the female screw portion through the screw hole.

6. The carbon dioxide recovery apparatus according to claim 1, further comprising
a first restriction structure, which is disposed between the assembly and the housing, and which restricts a displacement of the assembly in the insertion direction.

7. The carbon dioxide recovery apparatus according to claim 6, wherein
a fixing structure for fixing the assembly and the housing, and the first restriction structure are disposed on opposite sides to each other in a height direction of the housing.

8. The carbon dioxide recovery apparatus according to claim 6, wherein
the first restriction structure includes:
a first restriction protrusion portion, which protrudes from the assembly toward the housing; and
an abutment portion, which is disposed on the housing, and which abuts the first restriction protrusion portion in the insertion direction.

9. The carbon dioxide recovery apparatus according to claim 1, further comprising
a second restriction structure, which is disposed between the assembly and the housing, and which restricts a displacement of the assembly in a direction that intersects the insertion direction.

10. The carbon dioxide recovery apparatus according to claim 9, wherein
the fixing structure for fixing the assembly and the housing, and the second restriction structure are disposed on opposite sides to each other in a width direction of the housing.

11. The carbon dioxide recovery apparatus according to claim 9, wherein
the second restriction structure includes:
a second restriction protrusion portion, which protrudes from the assembly toward the housing, and in which a long hole is formed; and
a pin, which is disposed in the housing, and which is inserted into the long hole.

12. The carbon dioxide recovery apparatus according to claim 1, wherein
the support structure includes a side plate portion, which is disposed on an outer side in a width direction of the assembly, and which includes a recess portion formed to be capable of accommodating an end portion of the heat exchanger.

13. The carbon dioxide recovery apparatus according to claim 12, wherein
the recess portion is formed in a groove shape that conforms to a shape of the end portion of the heat exchanger.

14. The carbon dioxide recovery apparatus according to claim 1, further comprising
a header, which is disposed inside the housing, and which is for circulating a heat medium into the heat exchanger.

15. The carbon dioxide recovery apparatus according to claim 14, further comprising:
a circulation structure, which is disposed outside the housing, and which is for flowing the heat medium; and
piping, which penetrates into the housing to communicate inside of the circulation structure with inside of the header to circulate the heat medium into the header.

16. The carbon dioxide recovery apparatus according to claim 15, wherein
the piping has flexibility.

17. The carbon dioxide recovery apparatus according to claim 1, wherein
a pair of the slide members are disposed on both outer sides in a width direction of the housing.

18. The carbon dioxide recovery apparatus according to claim 17, wherein
a fixing structure for fixing the assembly and the housing, and one fastening portion of the pair of slide members are disposed on an identical side in a width direction of the housing.
